(19) United States
(12) Patent Application Publication
(10) Pub. No.: US 2009/0095522 A1
(43) Pub. Date: Apr. 16, 2009

(54) Robotic Bypass System and Method

(76) Inventor: Lionel O. Barthold, Lake George, NY (US)

Correspondence Address: MIRICK, O'CONNELL, DEMALLIE & LOUGEE, LLP, 1700 WEST PARK DRIVE, WESTBOROUGH, MA, 01581, US

(21) Appl. No.: 12/250,082

(22) Filed: Oct. 13, 2008

Related U.S. Application Data
(60) Provisional application No. 60/979,454, filed on Oct. 12, 2007.

(51) Int. Cl. H02G 7/05

(52) U.S. Cl. 174/40 TD

(57) ABSTRACT

A system and method, and robotic equipment for mechanical and/or electrical bypassing of short sections of energized high voltage line conductors by gripping the conductor at two close-by points, making good electrical and mechanical connection, then drawing the two points towards one another so as to relieve both mechanical and current-carrying duty of the bypassed conductor section. Doing so can provide slack on the bypassed conductor section for maintenance or repair while simultaneously providing an alternative path for electric current, or increase tension on the adjacent conductor sections by essentially shortening the conductor in the region where the invention is applied. The invention may then reverse direction, placing (stretch) tension on the bypassed conductor section and the point of repair to assure its mechanical integrity. Mechanical bypassing only to temporarily shorten specific conductor spans may be achieved by the same device. Electrical bypassing only may be achieved in a similar manner by gripping and bridging two separate high voltage conductors, thus providing a means to connect and/or disconnect them with the aid of switching equipment incorporated into the invention. The invention allows all of the foregoing to be accomplished at line potential and in close line proximity by virtue of its being mounted on an insulated boom or suspended from a hovering helicopter or suspended from the line itself.

### CROSS REFERENCE TO RELATED APPLICATION

This application claims priority of Provisional Application Ser. No. 60/979,454, filed on Oct. 12, 2007. The entire contents of this prior application are incorporated herein by reference.

### FIELD OF THE INVENTION

This invention pertains to the installation of electrical cables or conductors onto towers of high voltage electric power lines.

### BACKGROUND OF THE INVENTION

Maintenance and refurbishment of high voltage conductors is often done while a transmission line or substation remains in service. “Live-line” maintenance is usually achieved by lifting an enclosed platform (“bucket”) containing one or two linemen up to the conductors on an insulated boom. If the bucket is brought close to and electrically connected to a live high voltage conductor, it will assume the same potential as that of the conductors. Workers can make direct hands-on contact with the high voltage conductor and its associated hardware to make repairs without injury.

Live-line work, now aided by several robotic devices, may require lifting or repositioning one or more energized conductors when a portion of its supporting structure must be repaired or replaced. This was traditionally done by a conventional crane, from which an insulated cable section was suspended. It may now be done by a robotic arm, the top of which is shown in FIG. 1. See, e.g., U.S. Pat. No. 5,538,207 entitled “Boom-Mountable Robotic Arm”, the disclosure of which is incorporated herein by reference. The arm 10 in FIG. 1 is extendable by internal hydraulic pistons. Its attitude can also be adjusted hydraulically by an auxiliary support piston 11. The entire device is mounted on an extendable boom 12, similar to those used on bucket trucks for personnel. Since this robotic device is to lift energized conductors of differing potential, stand-off insulators 8 are required to lift more than one by the same arm 10. Atop each insulator is a conductor support 9 which includes a roller wheel 60 to allow the conductor longitudinal freedom of motion while being moved laterally. A latch 61 prevents the conductor from escaping from the support assembly 9. The conductor support device is shown in the open position in FIG. 1. Control of the hydraulically-based “telescoping” of robotic arms (adjusting their length), tilting them, and other robotic functions are achieved from a remote point.

The above patent provides control of conductors only in a plane transverse to the direction of the transmission line, i.e. vertical and lateral conductor motion, the conductor being free to move longitudinally on rollers 60 within the holder 9 in FIG. 1. In contrast, the robotic bypass device described herein, deals principally with longitudinal control of a conductor.

As further background for understanding of this invention, it will be useful to describe two prior art maintenance examples to which it can be applied to advantage.

### 1. Splice Replacement

FIG. 2 shows a defective splice or compression fitting 2 connecting two segments of an overhead high voltage conductor 1. FIG. 3 shows that to replace this splice, live line procedures are used to connect an electrical jumper 4 across the defective splice from point A to point B, anticipating its removal.

FIG. 4 shows that a chain hoist or “come-along” 5 has been mechanically tied to conductors by clamps 6, and used to pull up slack, thus relieving tension on the defective splice 2 and allowing its repair or replacement.

FIG. 5 shows that the defective splice 2 is cut from the conductor 1 at the splice edges x and y.

FIG. 6 shows the ends of the conductor 1 inserted into a new sleeve or compression fitting 7. The latter is then compressed, either by mechanical tools or by “implosion,” a method in which the sleeve is wrapped with explosives positioned to create high inward force, then ignited from the ground, the result being tight bonds between the connector 7 and the two ends of conductor 1.

The above operations are achieved from insulated boom-mounted buckets. The bucket first goes to point A, then to B for connection of the electrical bypass 4 and chain-hoist 5 attachments shown in FIG. 4. The bucket then moves to the splice point for the operations described above. On completion it returns to the ground, the sleeve is imploded, following which the bucket is again elevated to remove both the jumper 4 and the chain-hoist 5 in FIG. 4. Normally no mechanical test is made of the splice once it's installed, nor would such tests be convenient with prior art equipment.

### 2. Connection of Conductors at Different Potential

As further background to this invention, it will be useful to review, as one example, certain electrical connections necessary for replacement of conductors according to the method described in U.S. Patent Application 20050133244, “Live conductor stringing and splicing methods and apparatus”, incorporated herein by reference (termed herein the “phase d” method).

FIG. 7 shows a simplified electrical schematic of three phases of an alternating current high voltage power line, each carrying full load current, Iₐ, I_{b}, and I_{c} on permanent line conductors 1. A fourth (temporary) conductor section 13, “phase d,” typically several miles in length but otherwise connected neither to ground nor to the other conductors has been installed alongside the active phase conductors. It is to be connected, as shown in FIG. 7, to one of the permanent phase conductors; phase c in this case. With the switching device S₁ 15 in the open position, a relatively high voltage V_{d-c} may appear across the switch due to capacitive coupling from other conductors to conductor d. The switching device must be capable of withstanding that voltage in its open position. Once S₁ 15 is closed, a current of relatively few amperes will flow onto conductor d due again to capacitive coupling from the primary phases a, b, and c. When S₁ 15 is re-opened, that current must be interrupted. This switching duty can be handled by a conventional disconnect switch rated for the voltage at which the transmission line is operating.

FIG. 8 shows that, once S₁ 15 is closed, it may be necessary to connect the remote (right hand) end of the short conductor section 13 to the same phase conductor 1, thus forming a parallel path for current Iₐ. (In this application phase c will eventually be opened and all of the current I_{c} shifted to phase d while the phase c conductor is replaced) FIG. 8 shows the closing of the parallel phase c-d loop by a second switching device S₂ 29. In this case the switching requirement is quite different. A relatively low voltage V_{d-c} will appear across S₂ 29 while it is open; that voltage being due to inductive coupling from other current-carrying conductors. However when S₂ 29 is closed, conductor d will carry a substantial share of the current formerly carried solely by the phase which it parallels. This diverted current will often be in excess of 1,000 amperes. That current must be interrupted by S₂ 29 when it re-opens—a switching function which may require a circuit breaker rated for the current to be interrupted, rather than a disconnect switch. It will, however, be subject to a post-opening voltage well below the voltage of the transmission line being worked on.

Switching of this sort is presently achieved with the switching device 29 mounted on the ground, as shown in FIG. 8. In FIG. 8 the phase d conductor 13 is shown supported from a special temporary support point 16, while the main phase conductors are supported from the transmission tower itself 14. Both are suspended from those structures by means of insulator chains 31.

### SUMMARY OF THE INVENTION

This invention comprises both methods and apparatus, specifically a robotic bypass device, to simultaneously bypass, both mechanically and electrically short sections of transmission line conductors or to temporarily shorten a section of conductor by taking up slack on it. That purpose can be achieved by one or more “U” shaped bypass devices in which the upper extremities of the “U” grip a conductor mechanically and electrically after which (1) the width of the “U” is shortened, for example either by virtue of telescoping or a pantograph action, thus creating slack for repairs or replacement while providing an alternative path for current should the slack conductor section need to be cut for repairs then (2) causing the short section to be “stretched” or tensioned to a prescribed test tension level to assure its mechanical integrity prior to restoring it to service. The robotic bypass device may be mounted on and supported by an insulated, adjustable boom, suspended from a hovering helicopter, or supported by a high voltage conductor itself. The hydraulic supply which activates the clamps and articulation of the bypass device may also serve as a supply for hand-tools used by linemen for hands-on maintenance. Following repairs, the short section of line which the bypass device has made slack can then be “stretched,” by the robotic bypass device, i.e. subject to a controlled excess tension, to assure the integrity of the repaired conductor section. The invention displaces multi-step manual procedures requiring hand installation and removal of separate bypass jumpers and come-alongs, the latter being unable to exert excess test tension on a repaired conductor section to assure its post-repair integrity.

In another application, one which serves only an electrical purpose, one end of the robotic bypass device can be made to grip an energized and current-carrying high voltage conductor while the other end grips a separate high voltage conductor which may be energized or un-energized. In this embodiment the electrical path provided by the robotic bypass device may be open by virtue of an insulated section; its two ends being connected by either or both a high voltage disconnect switch or a low voltage circuit breaker incorporated into the device. This allows the two high voltage conductors to be temporarily connected or disconnected to or from one another, displacing the need for special bus-work and ground-mounted switchgear to temporarily connect and disconnect conductor sections.

This invention features a system for use with an energized high voltage line, comprising two spaced gripping devices for releasably gripping the high voltage line at spaced locations, and a system for changing the spacing between the gripping devices. The system can be configured to be located and operated at the height of and in close proximity to the high voltage line, being supported by an insulating boom, a helicopter-supported platform, or the high voltage line itself.

The system for changing the spacing between the gripping devices is preferably capable of either decreasing or increasing the spacing. The system for changing the spacing is preferably able to subject the line to greater-than-normal tension to test the mechanical integrity of the line or of repairs made to the line. The system preferably comprises a bypass conductor arranged to provide a bypass for electrical current from one gripping device to the other.

The system may comprise wire brushes for cleaning the line. The brushes can be made to first admit a short section of high voltage line, then close around that section, and then achieve axial motion along the line, to clean the surface of the line. The wire brushes can also be made to rotate relative to the line.

The system for changing spacing between the gripping devices may be capable of drawing together or moving apart the gripping devices by remote action. The gripping devices may comprise hydraulically controlled clamps. These clamps may remain closed upon loss of hydraulic pressure.

The invention also includes a system for use with an energized high voltage line, comprising two spaced gripping devices for releasably gripping the high voltage line at spaced locations, and a disconnect switch in order to electrically connect and disconnect two different gripped high voltage conductors. The invention further includes a system for use with an energized high voltage line, comprising two spaced gripping devices for releasably gripping the high voltage line at spaced locations, and a circuit breaker in order to electrically connect and disconnect two different gripped high voltage conductors.

The methods of the invention involve gripping the conductor at two spaced locations, bringing the gripped points closer together to slacken the line, bypassing current around the slackened portion, and removing and replacing some or all of the slackened portion. The gripped points may then be moved apart to place a certain amount of tension on the line. This method can be accomplished with the device and system described herein.

### BRIEF DESCRIPTION OF THE DRAWINGS

Other objects, features and advantages will occur to those skilled in the art from the following description of the preferred embodiments of the invention, and the accompanying drawings, in which like numbers are used for like parts, and wherein:

FIG. 1 schematically depicts a prior art robotic arm for lifting and positioning energized high voltage conductors.

FIG. 2 shows an existing conductor with a defective splice or compression joint.

FIG. 3 shows an electrical jumper positioned to bypass the defective splice or compression joint.

FIG. 4 shows slack drawn by a chain hoist or come-along to allow repair of the defective splice or compression joint.

FIG. 5 shows cuts (x and y) made to remove the defective splice or compression joint.

FIG. 6 shows the ends of the conductor placed inside a replacement sleeve or compression joint.

FIG. 7 is an electrical diagram showing a short section of un-energized conductor (“phase d”) being connected to or disconnected from an energized and current-carrying high voltage conductor.

FIG. 8 is an electrical diagram showing the closing or opening of a parallel path for current on a high voltage conductor.

FIG. 9 schematically depicts a prior art method of connecting an energized high voltage conductor to another parallel conductor.

FIG. 10 schematically depicts an embodiment of an inventive robotic bypass device gripping two nearby points of the same high voltage conductor.

FIGS. 11A, B and C show details of an embodiment of a conductor gripping device for the inventive robotic bypass device.

FIG. 12 is a cross-section of a construction for the conductor gripping device that allows a movable clamp body to slide within a fixed clamp body.

FIG. 13 shows an alternative cam-based device for pressing the movable clamp surface against the fixed clamp surface, in the open position.

FIG. 14 shows the device of FIG. 13 in the clamped or closed position.

FIG. 15 shows the robotic bypass device of FIG. 10 after having drawn slack on a short section of conductor.

FIGS. 16A and B are side and end views, respectively, of an alternative pantograph-based embodiment of the inventive robotic bypass device, in the extended position.

FIGS. 17A and B are side and end views, respectively, of the robotic bypass device of FIG. 16 in the contracted or closed position.

FIG. 18 shows a wire brush auxiliary device for cleaning a high voltage conductor prior to clamping, in the open position.

FIG. 19 shows the wire brush auxiliary device of FIG. 18 in the closed position.

FIG. 20 shows the wire brush auxiliary device of FIGS. 18 and 19 in a rotated position.

FIG. 21 shows an alternative embodiment of the wire brush auxiliary device, in the open position.

FIG. 22 shows the device of FIG. 21 in the closed position.

FIG. 23 shows an alternative embodiment of the robotic bypass device, fitted with a disconnect switch for connecting or disconnecting a high voltage conductor to or from an electrically separate high voltage conductor.

FIG. 24 shows another alternative embodiment of the robotic bypass device, fitted with a low voltage circuit breaker for connecting or disconnecting a high voltage conductor to or from an electrically separate high voltage conductor with which it shares current.

### DESCRIPTION OF THE PREFERRED EMBODIMENTS

### I. Mechanical & Electrical Bypass Functions

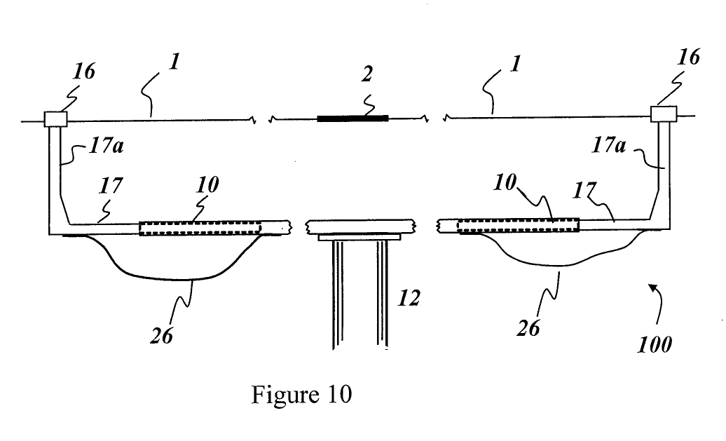

FIG. 10 is a simplified schematic of an embodiment of the inventive robotic bypass device 100, in this case mounted on an insulated boom, the robotic bypass device being adjustable in length hydraulically from a remote point. The mounting of the device on the insulated boom 12 is shown in simplified form, recognizing that adjustment and tilting capability of a boom-mounted device is known in the art and thus not shown in detail here, but could be incorporated in the robotic bypass device mounting mechanism. Also, the robotic bypass device could be incorporated into a helicopter-mounted platform, or could be supported by the high voltage line conductor itself. In FIG. 10 the robotic bypass device is positioned to grip the existing conductor 1 at points which straddle a defective splice 2. That positioning can be done from the ground, from a separate insulated bucket carrying the repair crew and hoisted to the same working location, or from a helicopter-supported platform.

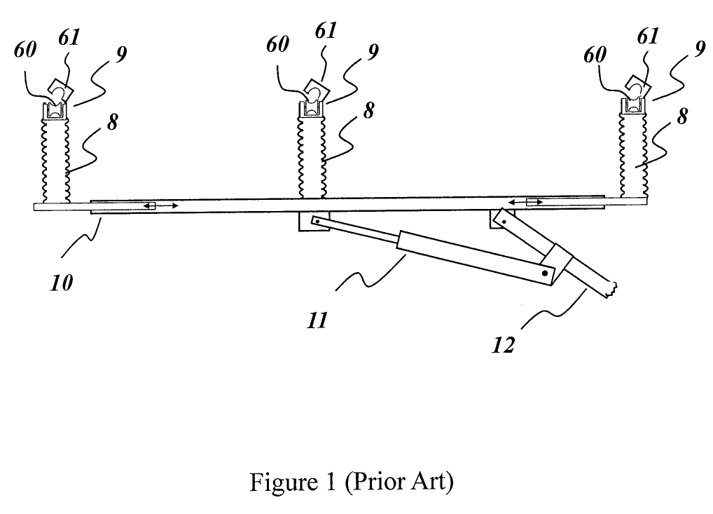

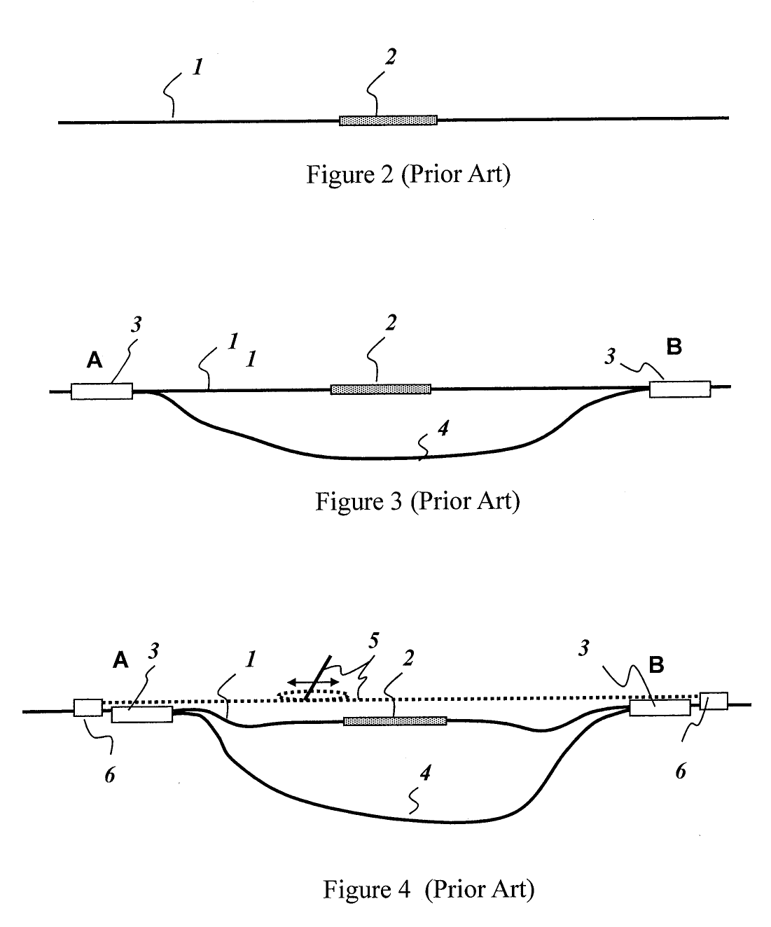

Robotic bypass device 100 includes fixed arm 17 that is made of aluminum or other high conductivity material capable of conducting high current, the path for which straddles the telescoping portion 10 of the arm via a bypass jumper 26. This construction allows the distance between clamps 16 to be altered, while still providing for bypass current flow through device 100. Because the arm may be relatively long, it is shown in break-away sections in the figure. Diagonal support and tilting arms extending from the insulated boom 12 to the telescoping arm 10 (prior art, such as shown in FIG. 1) may be required but are not shown for the sake of clarity. The vertical supporting arms 1 7a that carry clamps 16 at their ends may relatively short, unless implosive compression sleeves are anticipated in which case adequate vertical clearance must be provided between the sleeve and the robotic bypass device.

The robotic bypass device serves the purpose both of the bypass electrical jumper 4 and the chain hoist come-along 5 shown in FIG. 4.

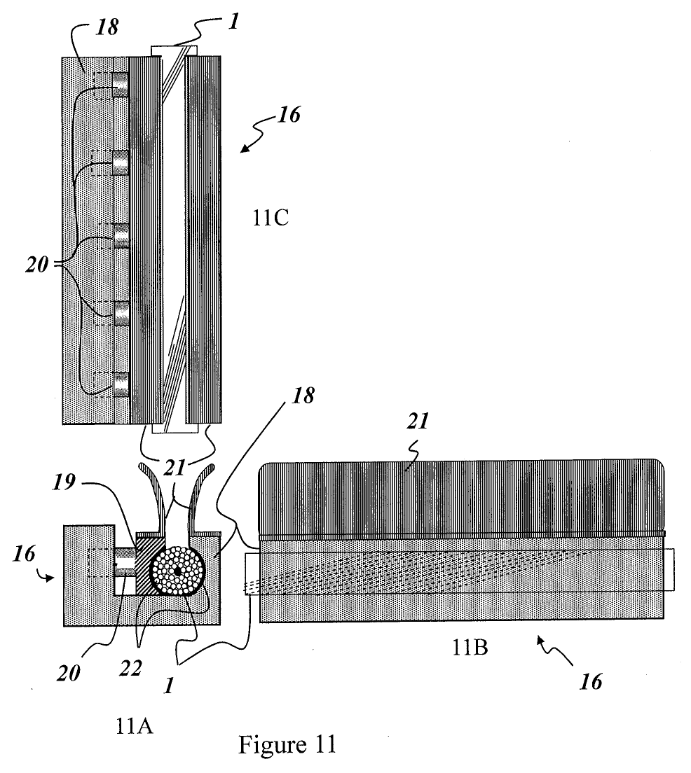

Robotic bypass device 100 comprises two conductor clamping devices 16 as well as fixed and extendable arms 10 and 17 respectively, and jumper 26 in FIG. 10. One of several possible configurations for clamping device 16 is shown in end, side, and top views in FIGS. 11A, B and C, respectively. In this case the clamp consists of a fixed member 18 which is integral with the clamp frame, and a moving member 19. Both are fitted with flared entry guide plates 21 to expedite capture of an energized conductor 1 by the clamp when in the open position.

The clamp faces are lined with a high conductivity material 22, e.g. an aluminum alloy, capable of gripping the conductor without damaging it. Before each application it may be coated with a high conductivity gel to aid in conductor-to-clamp current conduction. The contour of the clamp face may be interchanged so as to adapt to the size and shape of the high voltage conductor(s) being gripped.

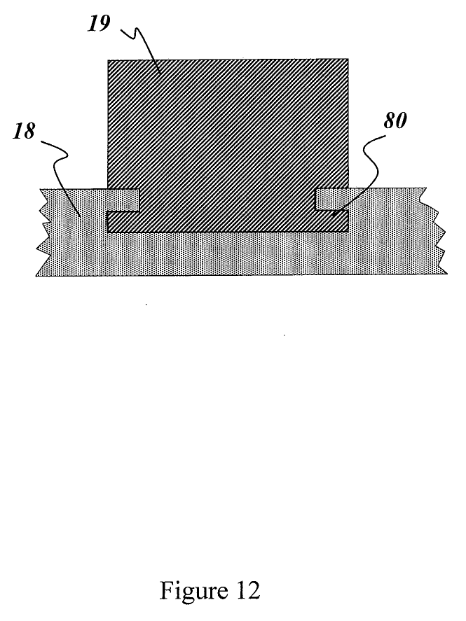

In this embodiment the movable clamp face 19 is forced against the conductor 1 by one or more hydraulic pistons 20, actuated from a remote point. The conductor 1 is then gripped between the movable clamp face 19 and the fixed clamp face 18. The movable clamp face 19 may be made to travel in a keyed groove 80, as shown in FIG. 12.

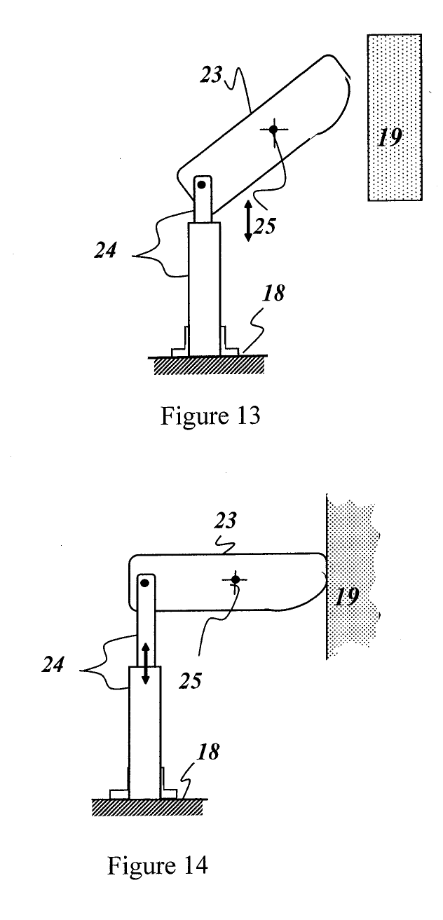

An alternative to the pistons which force the movable grip against the fixed grip shown in FIG. 11 is illustrated in FIGS. 13 and 14. One or more of the cam-based devices illustrated in those figures may serve the same function as do the pistons 20 in FIG. 11. In FIG. 13 the cam 23 is in the open position. Upon extension of the piston 24, as illustrated in FIG. 14, the cam 23 rotates clockwise on fixed pivot axis 25 and presses against the movable clamp frame 19, forcing it against the conductor and the fixed clamp frame 18 shown in FIG. 11. This alternative would prevent release of clamping pressure due to a hydraulic failure.

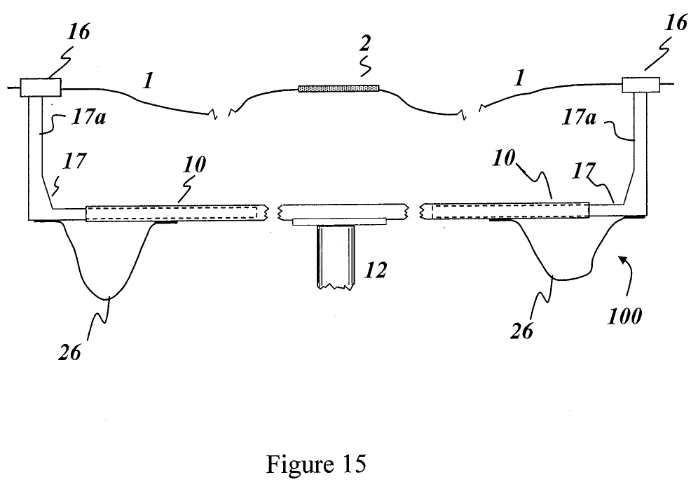

In FIG. 15 the robotic bypass device boom 10 has been shortened to the point where the boom assumes all of the line tension formerly borne by the conductor, thereby leaving slack for splice replacement. The current, formerly carried by the conductor 1 alone is now shared by that conductor and the robotic bypass device through the clamps 16, movable arms 17, jumpers 26, and fixed arm 10. Cutting out the splice and diverting all of the current to the robotic bypass device can be done without the use of switchgear. Splice replacement procedures, achieved by crew in a separate bucket or from a helicopter-supported work platform are done exactly as cited under “Background,” above.

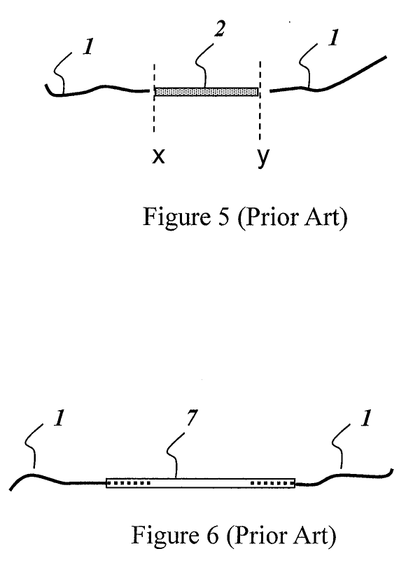

The explosive forces associated with implosive sleeves is largely directed inward, so the upward extension arms 17a shown in FIG. 5 need not be very long to prevent damage to the system from the explosion.

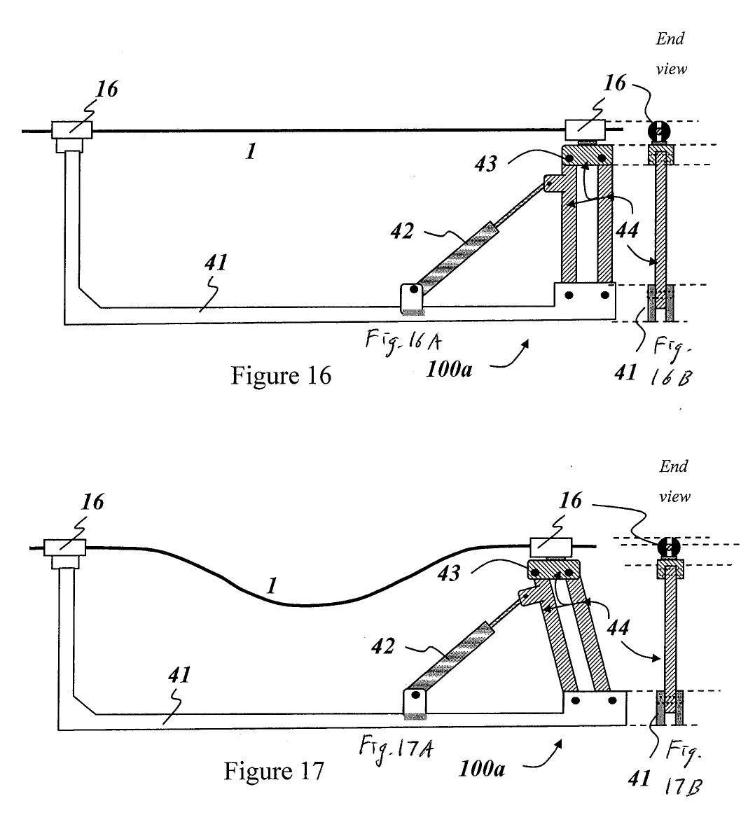

FIG. 16 shows another embodiment of the inventive robotic bypass device 100a; one in which contraction of the device is achieved by means of a pantograph mechanism consisting of a pair of parallel tilting arms 44 that pivot about their lower ends relative to frame 41, and end with portion 43 that remains horizontal, and carries conductor clamping device 16. FIG. 16 shows the embodiment in the extended position, having initially gripped the conductor by means of clamps 16. Arms 44 are then caused to rotate to the left by contracting piston 42, creating conductor slack as shown in FIG. 17. The pantograph assembly is shown on only one end of the robotic bypass device in FIG. 16 and 17, but may be installed at both ends to extend the degree of slack pulled on the conductor section.

The robotic bypass device of this invention will normally be equipped to transmit longitudinal force information to the operator at a remote point. Since mechanical characteristics of the conductor 1 are generally well known, longitudinal force is easily translated into conductor tension. Once the replacement sleeve 2 in FIG. 15 has been compressed either mechanically or implosively, the robotic bypass device can be extended, first to restore normal tension to the conductor, then to briefly exert a prescribed excess tension to assure that the sleeve is firmly gripping the conductor. This excess tension may be set equal to the maximum tension which the conductor is expected to see in service, e.g. tension resulting from winter ice loading. Once the repair operation is complete, the clamps 16 are then opened remotely and the robotic bypass device removed.

The principles and purposes of this invention may be achieved by many embodiments other than those illustrated in simplified form in FIGS. 10 and 16. The robotic bypass device needs to grip and release the line at two spaced points, and be constructed and operated such that these points can be brought closer together, in order to create the slack that allows the intermediate line to be cut and a portion of that line or devices installed thereon replaced. The device must be configured to carry the line current during this operation. As a desirable alternative, the device should be configured to push the grip points apart, so that the intermediate line can be tensioned in order to test a splice. Alternative constructions include combinations of the embodiments cited above, multiple or parallel relatively movable “U” or other shaped portions that releasably grip a conductor, or variations in the means by which two close-by points of a high voltage conductor are drawn together and/or “stretched” (tensioned to a desired degree) as described above while being bypassed electrically.

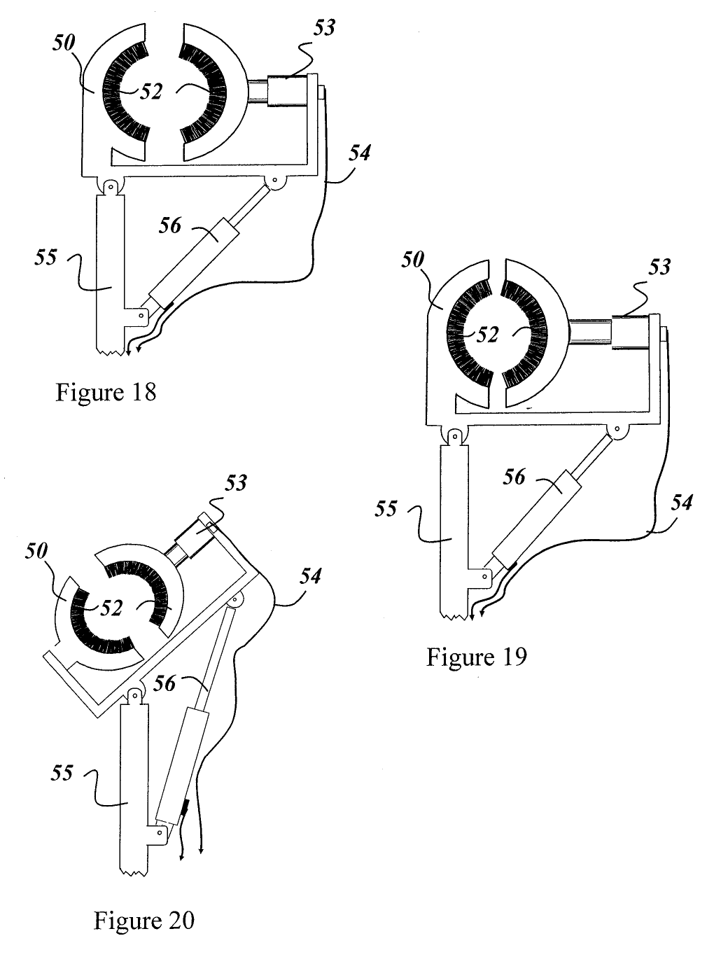

In the case of connector replacement and other maintenance operations requiring new electrical connections to a conductor, it is sometimes desirable to assure a better connection by first wire-brushing the conductor to remove burrs and oxidation. That function too can be achieved by either replacing or augmenting the conductor clamp in the robotic bypass device, an example embodiment of which is shown in FIGS. 11, 13 and 14. The brush heads equipped with wire bristles 52 are shown in the open position in FIG. 18 and shown closed by virtue of extension of hydraulic piston 53 fed by hydraulic line 54, as shown in FIG. 19. The brush head 50 can if desired be made to rotate to equalize brushing effectiveness around the circumference of the conductor by extension of second hydraulic piston 56 as shown in FIG. 20. In this case the robotic bypass device's movable frame extension (17 in FIG. 10 and 44 in FIG. 16) can be made to move backwards and forwards rapidly to achieve the cleaning function longitudinally.

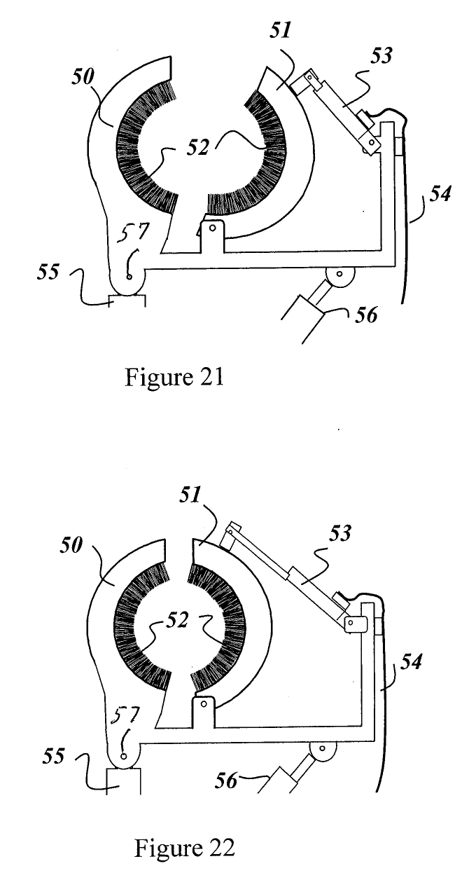

FIGS. 21 and 22 show an alternative brushing construction in which movable portion 51 carrying brush 52 is moved from the open position shown in FIG. 21 to the closed position shown in FIG. 22 via hydraulic piston 53. Second piston 56 rotates portion 50 about pivot axis 57 to accomplish cleaning.

### II. Electrical Bypass Function

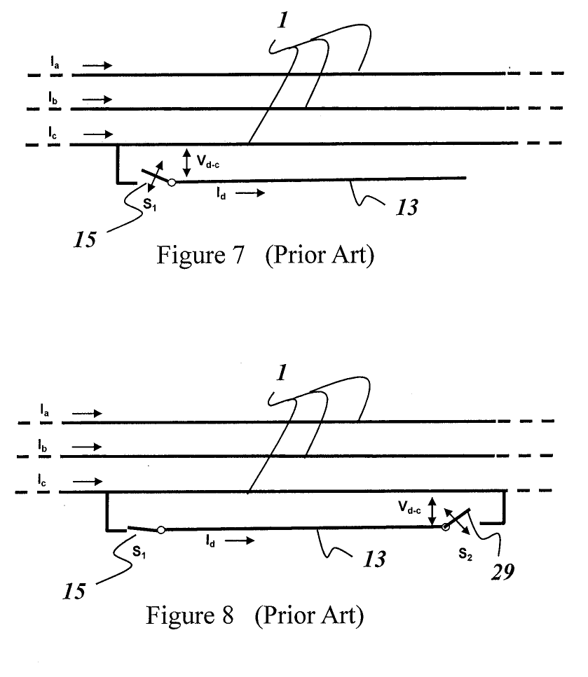

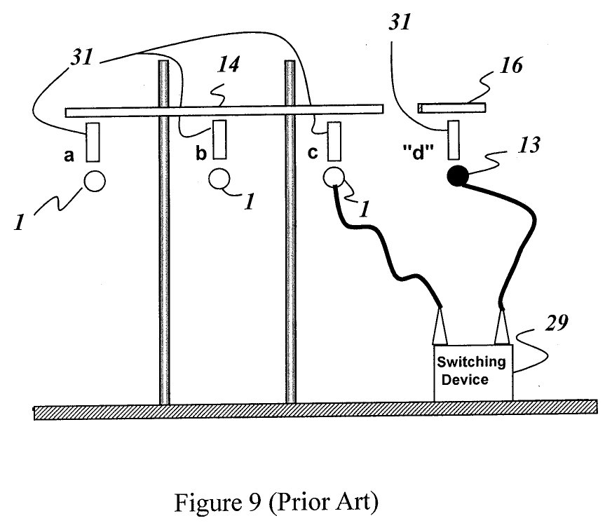

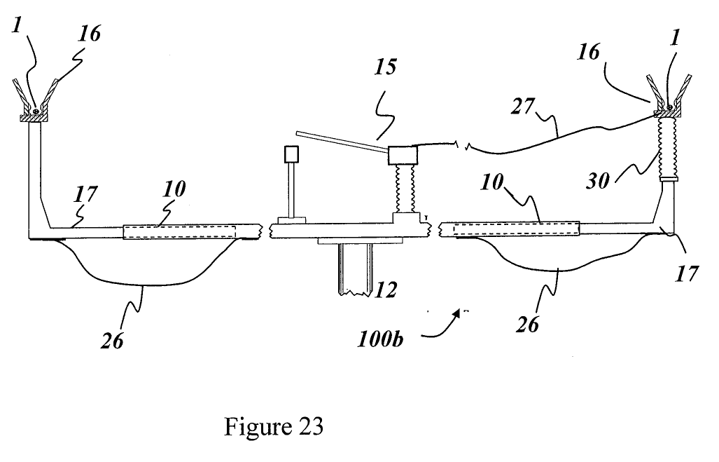

FIG. 23 illustrates an alternative robotic bypass device 100b configured for the electrical bypass function identified as S₁ 15 in FIG. 7. In this case, as previously, the arm assembly 17 and 10 may be relatively long and require lateral bracing to the insulated boom 12 (not shown). To compress the illustration of FIG. 7 the telescoping boom 10 is shown in break-away form.

The right hand side of FIG. 23 shows the clamp 16 mounted on the arm 17 by means of a standoff insulator 30 recognizing that the conductors held by left and right clamps may be at different potential. The right hand side of the disconnect switch 15 is connected by an electrical jumper 27 directly to the clamp 16. The left side of the disconnect switch 15 is connected directly to the fixed arm 10 of the robotic bypass device, then through the jumper 26 and to the clamp 16 atop the left vertical arm 17. Thus the robotic bypass device serves to insert a disconnect switch between the two arm extremities, either to bypass a defective switching device or to temporarily connect and disconnect electrically separate high voltage conductors where that duty can be handled by a disconnect switch.

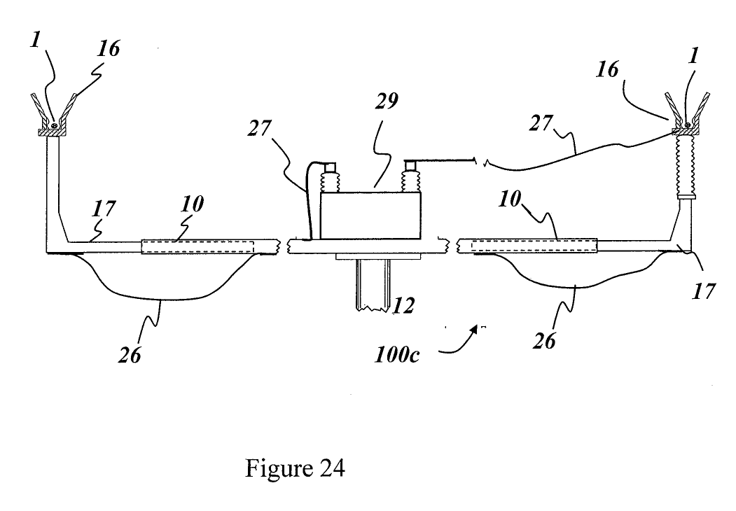

As noted previously switching between electrically separate high voltage conductors may impose requirement beyond those capable of being handled by disconnect switches. In this case the disconnect switch illustrated in FIG. 23 can be replaced by a vacuum circuit breaker 29 or equivalent device as shown in FIG. 24 in robotic bypass device 100c.

While not illustrated specifically, it will be apparent that the switching functions served by the disconnect switch 15 in FIG. 23 and the function served by the circuit breaker 29 in FIG. 24 could be served by the same robotic bypass device if both devices were mounted on the same robotic bypass device. If the two are connected in electrical series, then the switch not in use would be left in the closed position. If they were connected in electrical parallel, then the switch not in use would be left in the open position.

Examples of the need for switching operations cited in the preceding paragraphs are well illustrated in a patent application directed to replacement of existing conductors on high voltage transmission lines, US Patent Application 20050133244 entitled “Live conductor stringing and splicing method and apparatus”, incorporated herein by reference.

With respect to the above description then, it is to be realized that the optimum relationships for the elements of the invention, to include variations in size, materials, shape, form, function and manner of operation, assembly and use, are deemed apparent to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will occur to those skilled in the art, it is not desired to limit the invention to the exact construction and operation shown and described, and accordingly, all suitable modifications and equivalents may be resorted to, falling within the scope of the invention.

What is claimed is:

1. A system for use with an energized high voltage line, comprising:
two spaced gripping devices for releasably gripping the high voltage line at spaced locations; and
a system for changing the spacing between the gripping devices.

2. The system of claim 1, configured to be located and operated at the height of and in close proximity to the high voltage line, being supported by an insulating boom, a helicopter-supported platform, or the high voltage line itself.

3. The system of claim 2 in which the system for changing the spacing between the gripping devices is capable of either decreasing or increasing the spacing.

4. The system of claim 3 in which the system for changing the spacing is able to subject the line to greater-than-normal tension to test the mechanical integrity of the line or of repairs made to the line.

5. The system of claim 1 in which the gripping devices are capable of simultaneously achieving both good mechanical gripping and good electrical contact.

6. The system of claim 1 in which the system for changing spacing between the gripping devices also serves as a bypass for electrical current.

7. The system of claim 1 further comprising one or more devices for remotely cleaning the line with wire brushes to assure good electrical contact by the gripping devices.

8. The system of claim 7 in which the wire brushes can be made to first admit a short section of high voltage line, then close around that section, and achieve motion along the axis of the line, to clean the surface of the line.

9. The system of claim 8 in which the wire brushes are also made to rotate relative to the line.

10. The system of claim 1 in which the system for changing spacing is capable of drawing together or moving apart the gripping devices by remote action.

11. The system of claim 10 in which the gripping devices comprise a hydraulically controlled clamp that remains closed upon loss of hydraulic pressure.

12. The system of claim 1 further comprising a disconnect switch between the gripping devices in order to electrically connect and disconnect two different gripped high voltage conductors.

13. The system of claim 1 further comprising a circuit breaker between the gripping devices in order to electrically connect and disconnect two different gripped high voltage conductors.

14. A system for use with an energized high voltage line, comprising:
two spaced gripping devices for releasably gripping the high voltage line at spaced locations;
a system for changing the spacing between the gripping devices, the system for changing the spacing between the gripping devices being capable of either decreasing or increasing the spacing by remote action; and
conductive elements arranged to provide a bypass for electrical current from one gripping device to the other.

15. The system of claim 14 in which the gripping devices comprise hydraulically controlled clamps.

16. The system of claim 14 further comprising a disconnect switch between the gripping devices in order to electrically connect and disconnect two different gripped high voltage conductors.

17. The system of claim 14 further comprising a circuit breaker between the gripping devices in order to electrically connect and disconnect two different gripped high voltage conductors.

18. A system for use with an energized high voltage line, comprising:
two spaced gripping devices for releasably gripping the high voltage line at spaced locations; and
a disconnect switch between the gripping devices in order to electrically connect and disconnect two different gripped high voltage conductors.

19. A system for use with an energized high voltage line, comprising:
two spaced gripping devices for releasably gripping the high voltage line at spaced locations; and
a circuit breaker between the gripping devices in order to electrically connect and
disconnect two different gripped high voltage conductors.
